(19) United States
(12) Patent Application Publication
(10) Pub. No.: US 2024/0175451 A1
(43) Pub. Date: May 30, 2024

(54) ENERGY STORAGE SYSTEMS AND METHODS USING AN ENVIRONMENTAL WATER SOURCE

(71) Applicant: POWER8 TECH INC., Los Gatos, CA (US)

(72) Inventors: LIEN CHUN DING, Taoyuan (TW); CHIH CHENG TAI, Campbell, CA (US)

(21) Appl. No.: 18/519,316

(22) Filed: Nov. 27, 2023

Related U.S. Application Data
(60) Provisional application No. 63/428,297, filed on Nov. 28, 2022.

(51) Int. Cl. F15B 1/02; F15B 1/027; F15B 1/26

(52) U.S. Cl. CPC F15B 1/022; F15B 1/027; F15B 1/26

(57) ABSTRACT

A system for storing energy includes an energy storage apparatus having one or more energy storage storing water and compressed gas; and a water pump for supplying water from an environmental water source to the energy storage. The water source includes oceans, rivers, streams, lakes, reservoirs, spring water, groundwater, and reused water.

### CROSS-REFERENCE TO RELATED APPLICATIONS

This application claims priority to U.S. Provisional Application No. 63/428,297, filed on Nov. 28, 2022, and entitled “ENERGY STORAGE SYSTEMS AND METHODS USING AN ENVIRONMENTAL WATER SOURCE,” which is incorporated herein by reference for all purposes.

### FIELD OF THE DISCLOSURE

The present disclosure relates to systems for and methods of storing energy in an energy storage apparatus, and more particularly to the system directly delivers water from a ware source to the energy storage apparatus.

### BACKGROUND OF THE DISCLOSURE

Generally, the common way to generate power, including, but not limited to from fossil fuels or renewable resources, is complicated and expensive. Typical energy storage systems for electricity include batteries, flywheels, and pumped hydro storages. Any systems are limited in the total amount of energy they can store. The most common examples of energy storage are advanced batteries, such as, lithium-ion batteries. However, the advanced batteries cause high production costs and also the energy application is limited. Flywheels energy storage could provide high energy power but have low energy power density. Typical pumped hydro storage is very limited on locations which require specific geographical conditions.

### BRIEF SUMMARY OF THE DISCLOSURE

It is desirable to provide an energy storage system to reduce/avoid the transportation of water from a water source to the system and to recycle the water after processing by the system efficiently.

In an implementation, a system for storing energy comprises a concrete enhanced energy storage apparatus having one or more energy storage storing water and compressed gas; and a water pump for supplying water from an on-site/nearby water source to the energy storage system.

In some embodiments, the system further comprises a water tank connected to the water pump for storing water from the water source.

In some embodiments, the system further comprises a gas generator connected to the energy storage apparatus for supplying compressed gas to the energy storage apparatus.

In some embodiments, the system further comprises a transportation unit where the energy storage apparatus is displaced thereon.

In some embodiments, the system further comprises a desalination unit connected to the energy storage apparatus for converting salt water from a water source to form desalinated/purified water.

In some embodiments, the system further comprises a wastewater treatment unit connected to the energy storage apparatus for converting wastewater from a water source to form purified water.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a schematic drawing of a system for storing energy apparatus according to an embodiment.

FIG. 2 is a schematic drawing of a use of the storing energy apparatus in a mountain area according to an embodiment.

FIG. 3 is a schematic drawing of a use of the storing energy apparatus on a ship or boat according to an embodiment.

FIG. 4 is a schematic drawing of a system for storing energy in a concrete enhanced energy storage apparatus according to an embodiment.

FIG. 5 is a schematic drawing of the system for storing energy in the concrete enhanced energy storage apparatus according to another embodiment.

FIG. 6 is a schematic drawing of the system for storing energy in the concrete enhanced energy storage apparatus according to still another embodiment.

FIG. 7 is a flow chart schematically illustrating the energy storage method in accordance with some embodiments.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

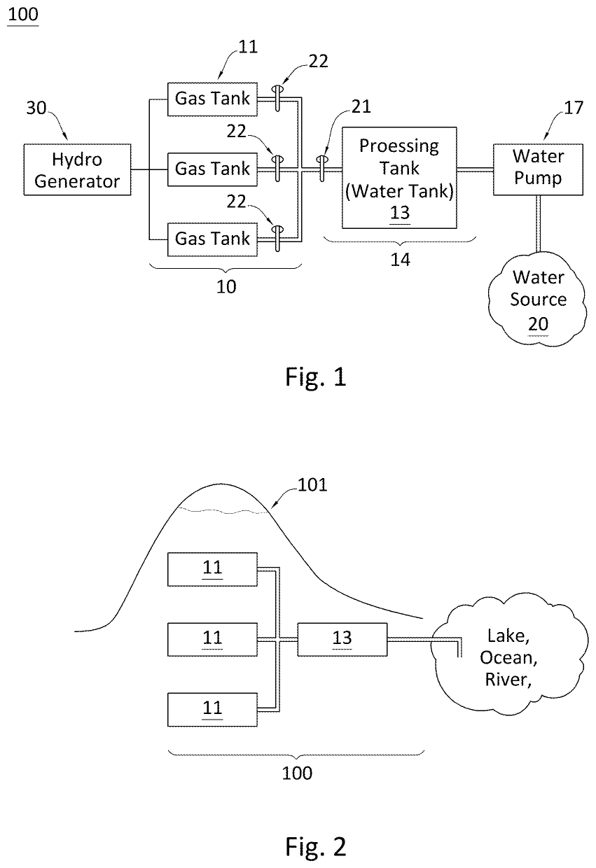

FIG. 1 is a schematic drawing of a system 100 for storing energy apparatus according to an embodiment. In one embodiment, the system 100 obtains water from a water source 20, which can be configured to be obtained ON-Demand, in real-time, or as needed basis so that the system 100 does not need to pre-store all needed water. Water source 20 may include oceans, rivers, streams, lakes, reservoirs, springs, groundwater (e.g., an aquifer), and reused water. It should be understood that the above-described water sources are exemplary, and any water sources can be adopted in various embodiments of this disclosure.

In one embodiment, the energy storage apparatus 10 comprise one or more energy storage 11 for storing water and compressed gas, a concrete layer encapsulating the energy storage 11, an inner protection layer on an inner surface of the energy storage 11, and a thermal path passed through the concrete layer and the inner protection layer. In some embodiments, the energy storage apparatus 10 is concrete enhanced, which is entirely encapsulated by concrete. In some embodiments, the energy storage apparatus 10 contains standalone metal tanks without concrete encapsulated. In some other embodiments, the energy storage apparatus 10 contain metal tanks with one or more partial portions that is encapsulated by concrete, polymer or any other protective materials.

In some embodiment, the water is stored in one of the energy storage 11 fluidly couple with another energy storage 11 that is used to store gas (e.g., inert gas, air, hydrogen). When more water (e.g., working liquid) is pumped into the energy storage 11 containing the water, such action reduced the spaces for storing gas so that the gas is compressed by the water. When the gas is compressed, the pressurized energy is stored.

In an energy release/electricity generation mode, the compressed gas releases the pressurized energy to push the water out of the energy storage 11 to drive the hydro generator 30 (e.g., water turbine) to generate the electricity. The water acting on the hydro generator 30 can be guided through the pipe to the energy storage 11 for recovery/recycle purposes.

In one embodiment, the energy storage 11 is used as a gas tank for storing gas and the system 100 may further comprise a water tank 13 controlled/communicated with the water distribution system 14 for storing water, which is delivered from the water source 20. The water in the water tank 13 can be guided to the gas tank 11. When more water enters the gas tank 13, the gas (e.g., inert gas, air, hydrogen) in the gas tank 11 is compressed by the water.

When the gas is compressed, the pressurized energy is stored. When the energy is needed, the compressed gas releases the pressurized energy to push the water out of the gas tank 11 to drive the hydro generator 30 to generate the electricity. The gas tank 11 can be pre-pressurized, such as 5 atm, 10 atm, 15 atm, 20 atm, 30, atm, 40 atm, 50 atm, 60 atm before the water is pumped from the water tank 13 into the gas tank 11. In some embodiments, a default pressure (pre-stored pressure) is set for the gas tank 11. The default pressure may be, but is not limited to, from 5 atm to 60 atm (e.g. 5 atm, 10 atm, 15 atm, 20 atm, 30, atm, 40 atm, 50 atm, 60 atm). In some embodiments, the water tank 13 is optional and is omitted, so that the water distribution system 14 can directly distribute water to the energy storage apparatus 10 without being stored first.

In one embodiment, the water pump 17 may be used to deliver water from the water source 20 to the energy storage apparatus 10, wherein the water pump 17 may be equipped with a meter to identify the amount of water dispensed to one or more energy storage 11. In still another embodiment, the system 100 may further comprise a processing unit 13 communicated to the water pump 17 and the energy storage 11, wherein the processing unit 13 may comprise a filter to remove dissolved solids or harmful substances. For one example, the filter may be a desalination unit for removing most of the dissolved solids and converting salt water from the water source to purified water. For another example, the filter may be a wastewater treatment unit for converting wastewater from the water source 20 to purified water. One or more valves 21, 22 are installed throughout the system 100, which can be controlled manually, electronically, and/or remotely (e.g., controlled via a GUI (Graphical user interface) user interface. A GUI uses windows, icons, and menus to carry out commands, such as opening, deleting, and moving files.)

In one embodiment, the system 100 for storing energy apparatus may further comprise hydro generator 30 (e.g., water turbine).

Constructions and operating methods of the energy storage/release in this disclosure are further disclosed in the associated patent applications U.S. patent application Ser. No. 17/777,516, PCT/US2022/029374, and CN202111466565.5, which are incorporated by references in their entirety for all purposes.

FIG. 2 is a schematic drawing of a use of the system 100 for storing energy apparatus in a mountain area according to an embodiment. The system 100 may comprise one or more energy storage 11 (e.g., gas tank) for storing water and compressed gas. The compressed gas may have a pressure in the range of from 5 atm to 60 atm (e.g., 10, 20, 30, 40, 50, 60 atm). The system 100 may further comprise a water tank 13 communicated to the energy storage 11 for storing water. The system 100 for storing energy apparatus can be installed in a mountain 101, a house, a factory, underground, or any other land-based areas. In some embodiments, the system 100 for storing energy apparatus can be configured as a long-term energy and water storage, such as 6 months, or two to three years. As a long-term energy and water storage, the system 100 for storing energy apparatus can be used as a reserve for wartime and disasters.

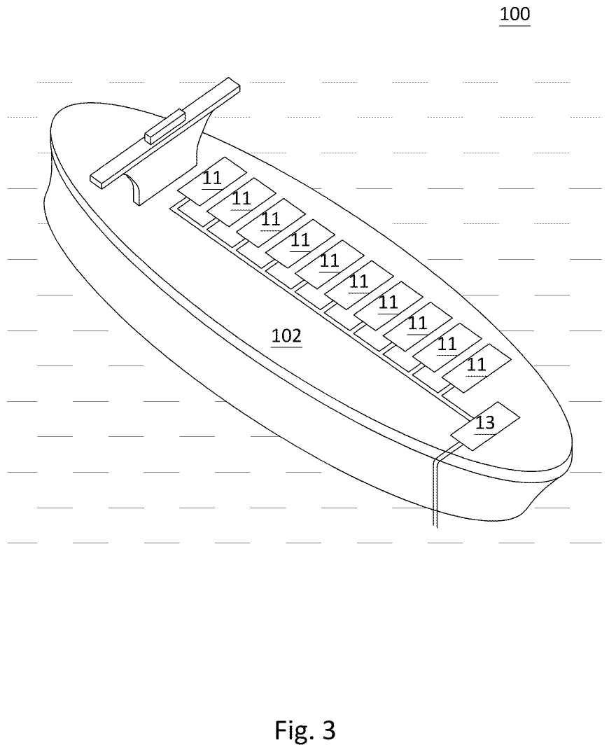

FIG. 3 is a schematic drawing of a use of the system 100 for storing energy apparatus on a ship according to an embodiment. The system 100 for storing energy apparatus can be installed in/on a ship 102 or any other mobile or moving vehicles including trucks, tanks, EV cars, houseboat, aircraft, and mobile homes. In some embodiments, the system 100 for storing energy apparatus can be configured as a long-term energy and water storage, such as 6 months, or two to three years. As a long-term energy and water storage, the system 100 for storing energy apparatus can be used as a reserve for wartime and disasters.

In some embodiments, the moving vehicles with the system 100 for storing energy apparatus can be called as “energy storage vehicle”, “energy storage shuttle”, and “mobile energy storage vehicle”.

In some embodiments, the energy storage vehicle further comprises a solar energy collection system (e.g., solar panel) or a wind turbine or both. The electricity generated by the solar energy collection system and the wind turbine can be stored in the system 100 for storing energy apparatus and the electricity is used to purify the water, grow food and vegetables, and treat the human waste and so on on the vehicle. With the solar energy collection system and the wind turbine, the vehicle can be self-sustaining and can be called as a “self-sustained vehicle” or “modern Noah arc”.

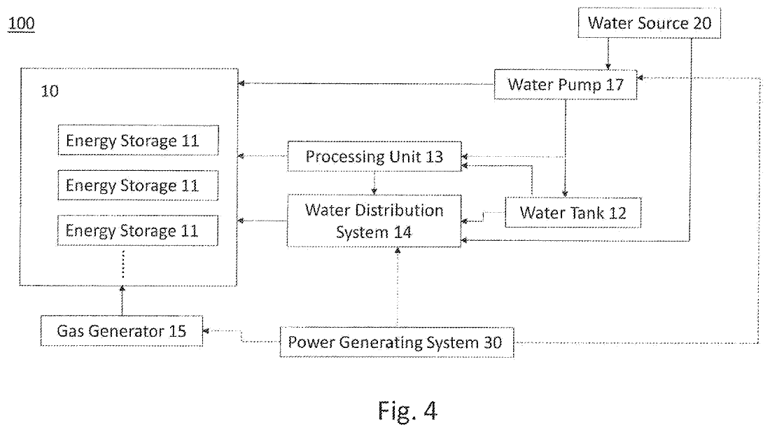

FIG. 4 generally depicts a system 100 for storing energy in a concrete enhanced energy storage apparatus 10 according to an embodiment.

Referring to FIG. 4, the system 100 may comprise the concrete enhanced energy storage apparatus 10 and a water pump 17 for supplying water from a water source 20 to the energy storage apparatus 10.

In one embodiment, the water source 20 may include oceans, rivers, streams, lakes, reservoirs, springs, groundwater (e.g., an aquifer), and reused water. It should be understood that the above-described water sources are exemplary, and any water sources can be adopted in various embodiments of this disclosure.

In one embodiment, the concrete enhanced energy storage apparatus 10 comprise one or more energy storage 11 storing water and compressed gas, a concrete layer encapsulating the energy storage 11, an inner protection layer on an inner surface of the energy storage 11, and a thermal path passed through the concrete layer and the inner protection layer.

In one embodiment, the system 100 may further comprise a water tank 12 communicated with the water distribution system 14 for storing water which is delivered from the water source 20.

In one embodiment, the water pump 17 may be used to deliver water from the water source 20 to the energy storage apparatus 10, wherein the water pump 17 may be equipped with a meter to identify the amount of water dispensed to one or more energy storage 11. In still another embodiment, the system 100 may further comprise a processing unit 13 communicated to the water pump 17 and the energy storage 11, wherein the processing unit 13 may comprise a filter to remove dissolved solids or harmful substances. For one example, the filter may be a desalination unit for removing most of the dissolved solids and converting salt water from the water source to purified water. For another example, the filter may be a wastewater treatment unit for converting wastewater from the water source to purified water. In one embodiment, the processing unit 13 may be communicated with the water tank 12. In one embodiment, the water pump 17 may be used to deliver water from the water source 20 to the processing unit 13.

In one embodiment, the system 100 may further comprise a water distribution system 14 communicated with the water pump 17, wherein the water distribution system 14 may comprise a controller to command and control the water delivered from the water pump 17 and allocate the water to one or more energy storage 11. The controller may be programmed to output certain amounts of water depending on one or more input variables. In one embodiment, the water distribution system 14 may receive the water treated in the processing unit 13.

In one embodiment, the system 100 may further comprise a gas generator 15 connected to the energy storage apparatus 10 for supplying compressed gas. For example, the gas generator 15 may be a hydrogen generator to generate hydrogen gas and compress the generated hydrogen gas into compressed hydrogen gas, wherein the compressed gas (hydrogen gas) may be delivered to the energy storage 11. It should be understood that the hydrogen gas is exemplary, and any suitable gas can be adopted in various embodiments of this disclosure. For example, the compressed gas may be hydrogen, air, or inert gas (e.g., helium or nitrogen).

As shown further in FIG. 4, a power generating system 30 may provide electrical power to the system 100. The power generating system 30 may generate electrical power and transmit the electrical power to one or more components of the system 100. In one embodiment, the power generating system 30 may provide electrical power to the water pump 17, the processing unit 13, and the gas generator 15. For example, in the embodiment of FIG. 1, the power generating system 30 may be the system 100 for providing solar energy collection with a modular design or array of solar energy collection devices or panels angled to the sun's position, wherein the solar energy collection system may collect and store solar energy and convert the solar energy to electrical power. In some embodiments, the power generating system 30 may be wind turbine.

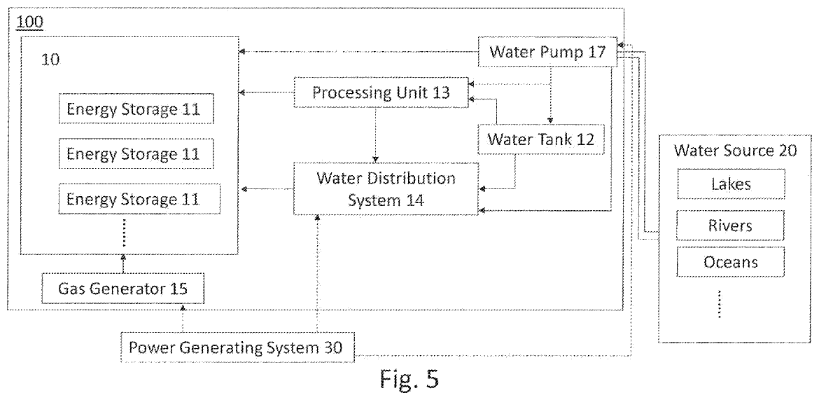

FIG. 5 generally depicts the system 100 for the concrete enhanced energy storage apparatus 10 according to another embodiment.

Referring to FIG. 5, the system 100 may be located adjacent to the water sources 20, such as oceans, rivers, streams, lakes, reservoirs, springs, and groundwater. In some embodiments, the water from the water source 20 may be guided to the system through at least one transportation channel.

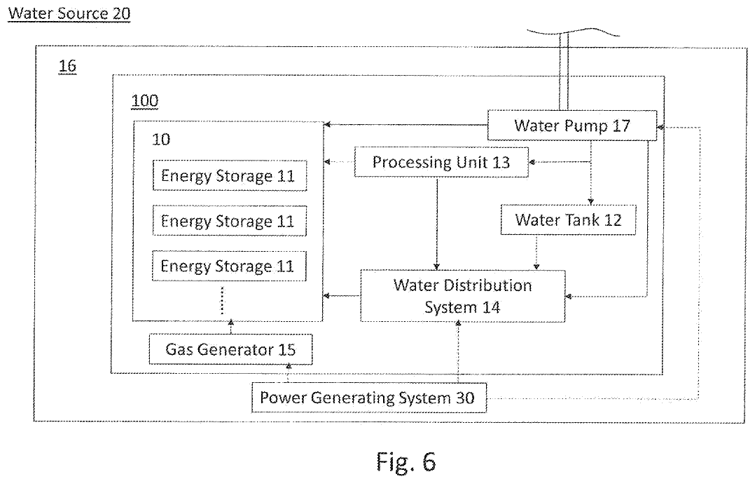

FIG. 6 generally depicts the system 100 for the concrete enhanced energy storage apparatus 10 according to still another embodiment.

Referring to FIG. 6, the system 100 may further comprise a transportation unit 16 where the energy storage apparatus 10 is displaced thereon, wherein the transportation unit 16 may comprise a cruise, a ferry boat, a cargo ship, aircraft, and an oil tanker. It should be understood that the above-described transportation units 16 are exemplary and any other transportation unit 16 can be adopted in various embodiments of this disclosure. In such a manner, the system 100 may move on the water source 20, which may facilitate the water from the water source 20 being delivered to the system.

As shown further in FIG. 6, a power generating system 30 may provide electrical power to the system 100. The power generating system 30 may generate electrical power and transmit the electrical power to one or more components of the system 100. In one embodiment, the power generating system 30 may provide electrical power to the water pump 17, the processing unit 13, and the gas generator 15. For example, in the embodiment of FIG. 3, the power generating system 30 may be power system of ship 102 or any other mobile or moving vehicles, so there is no need to another power generating system.

In utilization, the system 100 can be used as an energy storage, air/gas storage, fuel/fluid (e.g., water) storage facilities. The air, gas, water, and/or fuel stored can be used as needed, such as at drought or on fuel transportation trucks. As a long-term energy and water storage, the system 100 for storing energy apparatus can be used as a reserve for wartime and disasters.

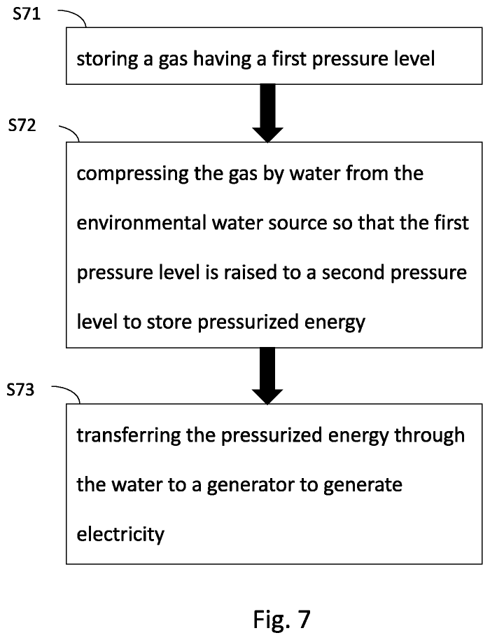

FIG. 7 is a flow chart schematically illustrating the energy storage method using an environmental water source in accordance with some embodiments. For easy understanding of this energy storage method, please also refer to FIG. 1. The method starts at Step S71. At Step S71, the method includes storing a gas having a first pressure level. The first pressure level can be set as a default pressure. The default pressure may range from 5 atm to 60 atm. The default pressure may be, but is not limited to, any one of the following values: 5, 10, 15, 20, 25, 30, 35, 40, 45, 50, 55, 60. The default pressure may fall within the ranges between any two of the above values. The gas may be stored in a container (e.g., the energy storage 11 as shown in FIG. 1 above) and then pressurized to the default pressure (e.g., 40 atm). The gas may include hydrogen, air or inert gas (e.g., helium or nitrogen).

At Step S72, the method includes compressing the gas by water from the environmental water source so that the first pressure level is raised to a second pressure level to store pressurized energy. The environmental water source may include oceans, rivers, streams, lakes, reservoirs, springs, groundwater (e.g., an aquifer), and reused water. As shown in FIG. 1, water may be pumped from the water source 20 (e.g., environmental water source) to the energy storage 11 (e.g., a gas tank). When more water is pumped into the energy storage 11, the stored gas is compressed by the water so that the pressure of the gas is raised from the first pressure level (e.g., 35, 40 atm) to a second pressure level (e.g., 55, 60 atm) to store pressurized energy.

At Step S73, the method includes transferring the pressurized energy through the water to a generator to generate electricity. When energy is required, the pressurized energy can be partially or fully released. If the gas and water in the energy storage 11 have no other leaking path except the hydro generator 30, the pressure difference between the second pressure level and the first pressure level forces the water out of the energy storage 11 towards the hydro generator 30 (e.g., water turbine), which drives the hydro generator 30 to generate electricity. After the release of the pressurized energy, the pressure of the gas in a container (e.g., the energy storage 11) is reduced from the second pressure level to a third pressure level. The third pressure level may be greater than, equal to, or less than the first pressure level, depending on the amount of the pressurized energy released. The third pressure level may range from 5 atm to 60 atm. In some embodiments, the first pressure level is 40 atm and the third pressure level is 40 atm. In some embodiments, the pressurized energy is released by partially or completely discharging the water from the energy storage 11.

The energy storage method can be applied to transportation unit (e.g., a cruise, a ferry boat, a cargo ship, oil tanker, trucks, tanks, EV cars, houseboat, aircraft, or mobile homes) for building a self-sustaining environment. In one embodiment, the energy storage method is applied to a ship (e.g., a cargo ship). The ship can use the electricity generated by the method to purify the water, grow food and vegetables, and treat the human waste, etc., thereby building a self-sustaining environment. In some embodiments, the ship may be provided with a solar energy collection system (e.g., a solar panel), a wind turbine, or both.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of the systems and methods for storing energy in the concrete enhanced energy storage apparatus have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A system for storing energy, the system comprising:
a concrete enhanced energy storage apparatus having one or more energy storage storing water and compressed gas; and
a water pump for supplying water from a water source to the energy storage.

2. The system of claim 1, further comprising a water tank communicated to the water pump for storing water from the water source.

3. The system of claim 1, further comprising a gas generator communicated to the energy storage apparatus for supplying the compressed gas to the energy storage.

4. The system of claim 1, further comprising a transportation unit where the energy storage apparatus is displaced thereon.

5. The system of claim 4, wherein the transportation unit is a cruise, a ferry boat, a ship, oil tanker, trucks, tanks, EV cars, houseboat, aircraft, or mobile homes.

6. The system of claim 1, further comprising a processing unit connected to the energy storage apparatus for converting salt water from the water source to purified water.

7. The system of claim 1, further comprising a processing unit connected to the energy storage apparatus for converting wastewater from the water source to purified water.

8. The system of claim 1, further comprising a power generating system for providing electrical power to the system.

9. The system of claim 8, wherein the power generating system is a solar energy collection system or wind turbine.

10. The system of claim 1, further comprising a water distribution system which comprises a controller to control the water delivered from the water pump and allocate the water to the energy storage.

11. The system of claim 1, wherein the water source is oceans, rivers, streams, lakes, reservoirs, springs, groundwater, or reused water.

12. An energy storing system using a natural water source comprising:
a gas tank storing a gas;
a water pump supplying water from the natural water source to compress the gas; and
a hydro generator receiving the water discharged from the gas tank by releasing the compressed gas to generate electricity.

13. The energy storing system of claim 12, wherein the gas has a pressure ranging from 5 atm to 60 atm.

14. The energy storing system of claim 12, wherein the gas comprising inert gas, air, or hydrogen.

15. The energy storing system of claim 12, wherein the natural water source is oceans, rivers, streams, lakes, reservoirs, springs, groundwater, or reused water.

16. The energy storing system of claim 12, further comprising a transportation unit where the gas tank is displaced thereon.

17. An energy storage method using an environmental water source comprising:
storing a gas having a first pressure level;
compressing the gas by water from the environmental water source so that the first pressure level is raised to a second pressure level to store pressurized energy; and
transferring the pressurized energy through the water to a generator to generate electricity.

18. The energy storage method according to claim 17, wherein the environmental water source is oceans, rivers, streams, lakes, reservoirs, springs, groundwater, or reused water.

19. The energy storage method according to claim 17, wherein the gas comprising hydrogen, inert gas or air.

20. The energy storage method according to claim 17, wherein the first pressure level ranges from 5 atm to 60 atm.

21. The energy storage method according to claim 17, further comprising using the electricity to build a self-sustaining environment.
